(19) United States
(12) Patent Application Publication
(10) Pub. No.: US 2011/0125579 A1
(43) Pub. Date: May 26, 2011

(54) Apparatus, Methods, and Computer Program Products for Facilitating Dynamic Search Engine Service Competition

(76) Inventor: William Coan, Monroe, WA (US)

(21) Appl. No.: 12/622,459

(22) Filed: Nov. 20, 2009

(51) Int. Cl. G06Q 30/00; G06Q 50/00; G06Q 20/00

(52) U.S. Cl. 705/14.54; 705/14.7; 705/14.71; 705/26.3

(57) ABSTRACT

Apparatus, methods and/or computer program products are provided that facilitate selecting a search engine for performing a search request by soliciting bids from a plurality of search engine services. The search request is awarded to a search engine service that submits a bid that best satisfies user criteria, such as search engine preference, search results format preference, and price. Apparatus, methods and/or computer program products also are provided that facilitate submitting a bid for the right to provide search results for a user search request. The search engine service with the winning bid performs a search using the search request, acquires advertising to be displayed with the search results, and provides the search results and advertising to the user. The search engine service pays the user and/or a network service provider a portion of advertising revenue.

### BACKGROUND

The present application relates generally to computer systems and applications, and, more particularly, to search engine services for searching computer networks, such as the Internet.

Communications networks are widely used for nationwide and worldwide communication of voice, multimedia and/or data. As used herein, the term “communications network” includes public communications networks, such as the Public Switched Telephone Network (PSTN), terrestrial and/or satellite cellular networks, private networks and/or the Internet.

The Internet is a decentralized network of computers that can communicate with one another via Internet Protocol (IP). The Internet includes the World Wide Web (web) service facility, which is a client/server-based facility that includes a large number of servers (computers connected to the Internet) on which web pages or files reside, as well as clients (web browsers), which interface users with the web pages. The topology of the web can be described as a network of networks, with providers of network services called Network Service Providers, or NSPs. Servers that provide application-layer services may be referred to as Application Service Providers (ASPs). Sometimes a single service provider provides both functions.

A search engine is a computer program that retrieves documents or files or data from a database or from a computer network, such as the Internet. Search results conventionally are presented in a list and are commonly called hits. Search results may include web pages, images, audio files, video files, and various other types of information and files. Exemplary conventional search engines include, among others, the GOOGLE® search engine, the YAHOO® search engine, and the BING® search engine.

When a user enters a query into a search engine, the search engine examines an existing index and provides a list of best-matching results, usually with a short summary containing a title and sometimes parts of text. Most search engines are commercial services that generate advertising revenue. In some cases, search engines allow advertisers to pay to have their listings ranked higher in search results. In some cases, search engines generate revenue by displaying search-related ads alongside search engine results. The search engines generate revenue every time someone clicks on one of these ads.

Typically, a search engine is selected by an individual user or, in some cases, by a network service provider. In either case, a user typically uses the same search engine over and over. However, some search engines may be better than others for particular types of searches and may provide a user with results more suited to the user. However, currently a user may not know what search engine is particularly suited for his/her search.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

In some embodiments, a method of selecting a search engine for performing a search request includes soliciting bids from a plurality of search engine services for performing a user search request in response to a user entering the search request into a device. The solicitation can be initiated by a network service on the communications network and/or by a program executing on a device into which the search request is entered. The search request is awarded to a search engine service that submits a bid that best satisfies user criteria, such as user search engine preference, search results format preference (e.g., formatted for a desktop computer, a handheld computer, a mobile phone, etc.), and price a search engine service is willing to pay to perform the search request and/or for one or more search terms in the search request.

In some embodiments, a method of providing search results to a user includes a search engine service submitting, a bid for the right to provide search results for a user search request, in response to receiving a bid request. The bid includes information as to how the search results will comply with various user criteria. In some embodiments, the search engine service obtains user criteria information prior to submitting the bid so as to enable the search engine service to provide information relevant to the particular user. The search engine service with the winning bid performs a search (e.g., examines an existing, list maintained by the search engine) using the search request, acquires advertising to be displayed with the search results, and provides the search results and advertising to the user. In addition, the search engine service pays the user and/or a network service provider a portion of advertising revenue received by the search engine service for the advertising.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that mariner. These and other objects and/or aspects of the present invention are explained in detail in the specification set forth below.

Other methods, apparatus and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a flowchart that illustrates exemplary operations for selecting a search engine service, according to some embodiments.

FIG. 2 is a block diagram of a communications network according to some embodiments.

FIG. 3 is a user device interface for entering a search request according to some embodiments.

FIG. 4 is a flowchart that illustrates exemplary search engine service operations, according to some embodiments.

FIG. 5 is a block diagram that illustrates details of an exemplary processor and memory that may be used to select a search engine service, according to some embodiments.

FIG. 6 is a block diagram that illustrates details of an exemplary processor and memory that may be used to submit bids for search requests and pay a portion of advertising revenue to a user, according to some embodiments.

### DETAILED DESCRIPTION

While various modifications and alternative forms of the embodiments described herein may be made, specific embodiments are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing, apparatus to produce a machine, such that the instructions, which execute via the processor of the computer and/or other programmable data processing apparatus, create means (functionality) and/or structure for implementing, the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Embodiments promote competition between search engine services and allow end users to dynamically change the search engine they use based on various user criteria, search terms, and price that a search engine service is willing to pay an end user to provide search results. Embodiments also allow for greater distribution of the revenue generated through sponsored advertising links, key terms, etc.

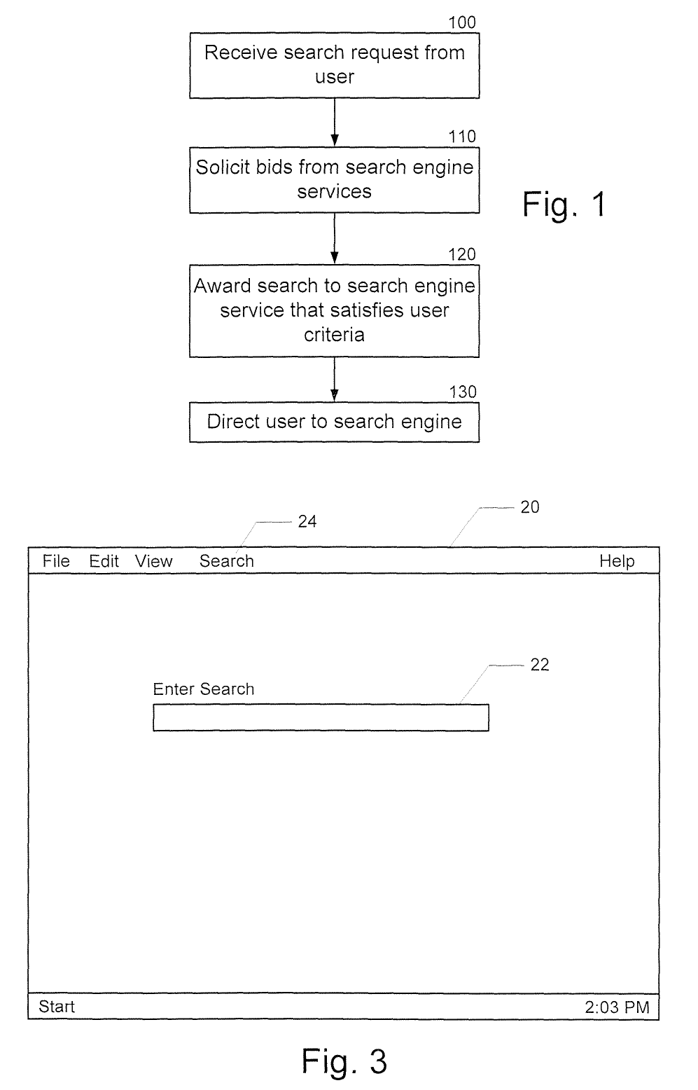

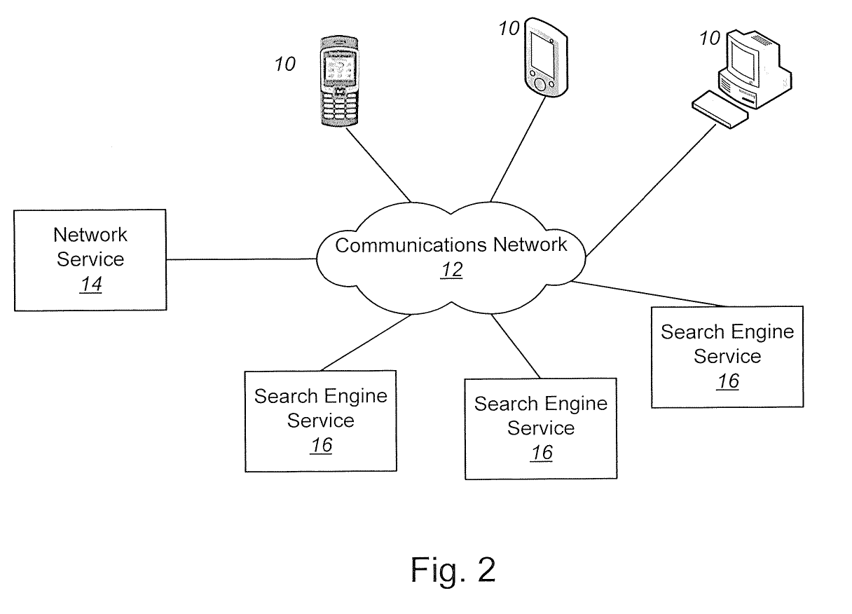

FIG. 1 is a flowchart that illustrates exemplary operations for selecting a search engine service, according to some embodiments. Initially, a search request (e.g., one or more search terms, phrases, etc.) is received from a user (Block 100) who has entered the search request into a user device 10 (FIG. 2) connected to a communications network 12 (FIG. 2). A network service 14 (FIG. 2) associated with a network service provider of the communications network 12 (FIG. 2) may be the receiving entity of the search request. The user device 10 may be any type of device including, but not limited to, a desktop computer, a handheld computing device, a mobile phone, a set top box for IP television (IPTV), etc.

Rather than initially selecting a search engine, such as the GOOGLE® search engine, and entering a search request, a user enters the search request via some type of user interface displayed on the user device 10 (FIG. 2). For example, as illustrated in FIG. 3, a graphical user interface (GUI) 20 displayed within a user device allows a user to launch a search engine-agnostic program (e.g., an application, applet, script, agent, etc.) that displays a search term entry box 22. In the illustrated embodiment, the search engine-agnostic program is initiated via selection of the “Search” tab 24 displayed in the GUI 20. However, various ways are possible for a user to enter search terms within a user device. Embodiments of the present invention are not limited to entering search terms within a GUI. For example, in some embodiments, a search term may be entered within a command line interface of a device. In some embodiments, a user may enter search terms within a program, such as a browser, executing, on the device. The term “search engine-agnostic” means that the user interface that is used to enter a search request and the program that generates the user interface are not associated in any way with any particular search engine.

Referring back to FIG. 1, the entity receiving the user search request, e.g., the network service 14 (FIG. 2), solicits bids from multiple search engine services 16 (FIG. 2) via the communications network 12 (FIG. 2) (Block 110). The search request is then awarded to the search engine service that submits a bid that best satisfies user criteria (Block 120). User criteria may include various user preferences, such as search engine preference and search results format preference. Search results format preference includes whether the search results can be formatted for viewing by, for example, a mobile device, by a desktop device, and/or by an IPTV set top box (STB), etc. In addition, user criteria may include the price a search engine service is willing to pay to perform the particular search request and/or the price a search engine service is willing to pay for one or more search terms in the search request. The price a search engine service is willing to pay for one or more search terms in a search request can depend on various factors including, but not limited to, time of day, user location, user device, user profile, user service plan with a network service provider, previous user activity, user friends, association of the search request with a program (e.g., radio program, television program, etc.), and association of the search request with advertising in other media (e.g., newspaper advertising, magazine advertising, billboard advertising, etc.).

The search engine service that submits the winning bid is awarded the right to perform the search request for the user. The network service 14 (FIG. 2) then facilitates user access to the search engine of the search engine of the search engine service (Block 130). This may include directing the user device to the web site of the search engine of the winning search engine service. In some embodiments, the user device may include a program (e.g., an agent, etc.) associated with the search engine of the winning, search engine service and may automatically connect the user device to the search engine in response to the network service awarding the bid. In some embodiments, the search engine results may be proxied/displayed by the network service.

In other embodiments, operations described above with respect to FIG. 1 may be performed via a user device 10 (FIG. 2) without intervention from a network service. For example, the user device 10 into which a user enters a search request (Block 100) may execute a program that solicit bids from search engine services (Block 110) via a communications network 12 (FIG. 2) and awards the search to a search engine service that best satisfies user criteria (Block 120). The program can then direct a browser executing on the user device to the web site of the search engine of the winning search engine service. In some embodiments, the user device may include a program associated with the search engine of the winning search engine service and may automatically connect the user device to the search enaine in response to awarding the bid.

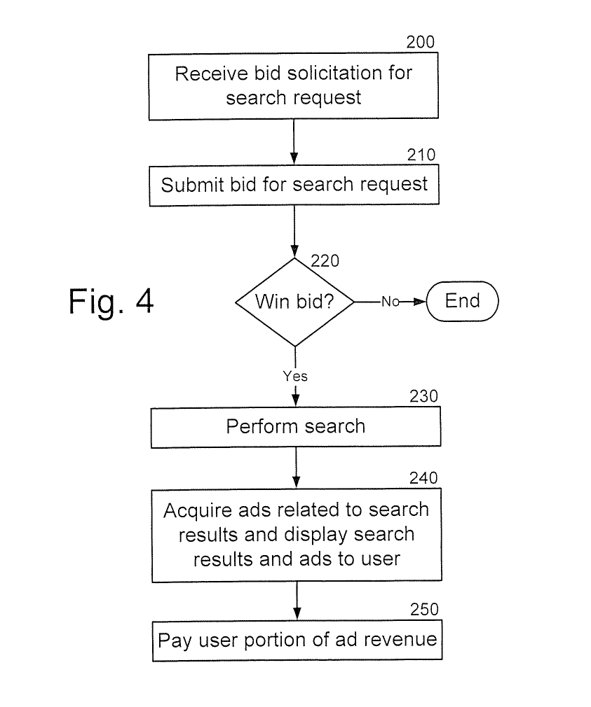

Referring now to FIG. 4, exemplary operations performed by a search engine service in bidding on a search request and performing the search request are illustrated. In response to receiving a bid request (Block 200), for example, from a network service 14 (FIG. 2) or from a program executing on a user device 10 (FIG. 2), a search engine service 16 (FIG. 2) submits a bid for the right to provide search results for a user search request (Block 210). As described above, the submitted bid includes information as to how the search results will comply with user criteria, including user preferences such as search engine preference, search results format preference, the price the search engine service is willing to pay to perform the particular search request, etc.

In some embodiments, a search engine service, upon receiving a bid solicitation, may request information from the network service or from the user device about user criteria. For example, the search engine service may not know what format the user is interested in receiving, search results and may request this information. As another example, the search engine service may want to know what the minimum price a user or network service provider is willing to accept for performing a search and submitting the search results.

When a search engine service submits a winning bid (Block 220), a search is performed (e.g., a list is examined) using the search request entered by the user (Block 230). Advertising related to the search results is acquired, for example, from third parties and other advertising, sources, and the search results and associated advertising are sent to the user device for display (Block 240). A portion of the advertising revenue that the search engine service will receive from advertising sources is then paid to the user and/or to the network service provider (Block 250). The acquisition of advertising by a search engine and the generation of advertising revenue in response thereto is well understood by those skilled in the art and need not be described further herein. The payment of revenue users may be performed in various ways and at various times, without limitation. For example, payment can occur substantially at the same time with search results or can occur at a later time. In some embodiments, credits for goods and/or services may be made in lieu of cash payments, etc.

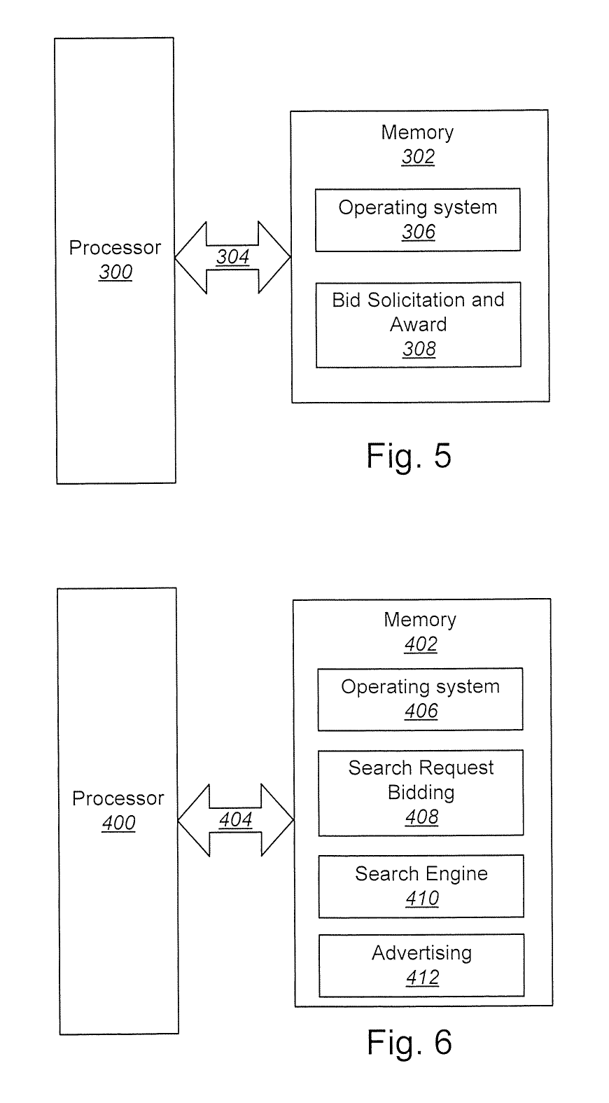

FIG. 5 illustrates an exemplary processor 300 and memory 302 that may be used to select a search engine service, according to some embodiments. The processor 300 communicates with the memory 302 via an address/data bus 304. The processor 300 may be, for example, a commercially available or custom microprocessor. The memory 302 is representative of the overall hierarchy of memory devices containing the software and data used to implement a device or system for selecting a search engine service as described herein, in accordance with some embodiments. The memory 302 may include, but is not limited to, the following types of devices: cache, ROM, PROM, EPROM, EEPROM, flash, SRAM, and DRAM.

As shown in FIG. 5, the memory 302 may hold various categories of software and data: an operating system 306, and a bid solicitation and award module 308. The operating system 306 controls operations of a device (e.g., a network service 14 and/or a user device 10) used to solicit bids from multiple search engine services 16 and award the right to perform a search for a user upon the submission of a winning bid. In particular, the operating system 306 may manage the resources of a device 10, 14 and may coordinate execution of various programs (e.g., the bid solicitation and award module 308, etc.) by the processor 300.

The bid solicitation and award module 308 comprises logic for soliciting bids from a plurality of search engine services 16 and for awarding a search engine service 16 the right to perform a search in response to submitting a winning bid.

FIG. 6 illustrates an exemplary processor 400 and memory 402 that may be used by a search engine service 16 to bid on search requests, perform search requests, and pay a portion of advertising revenues to end users, according to some embodiments. The processor 400 communicates with the memory 402 via an address/data bus 404. The processor 400 may be, for example, a commercially available or custom microprocessor. The memory 402 is representative of the overall hierarchy of memory devices containing the software and data used to implement a device or system for bidding on search requests, performing search requests, and paying a portion of advertising revenues to users as described herein, in accordance with some embodiments. The memory 402 may include, but is not limited to, the following types of devices: cache, ROM, PROM, EPROM, EEPROM, flash, SRAM, and DRAM.

As shown in FIG. 6, the memory 402 may hold various categories of software and data: an operating system 406, a search request bidding module 408, a search engine module 410, and an advertising module 412. The operating system 406 controls operations of a search engine service device (e.g., one or more servers) used by a search engine service 16 to bid on search requests, perform search engine services, including acquiring and combining advertising with search results, and paying a portion of advertising revenues to end users. In particular, the operating system 406 may manage the resources of a device and may coordinate execution of various programs (e.g., the search request bidding module 408, the search engine module 410, the advertising module 412, etc.) by the processor 400.

The search request bidding module 408 comprises logic for submitting a bid for the right to provide search results for a user search request, in response to receiving a bid request. The search request bidding module 408 may also comprise logic for obtaining user criteria information prior to submitting a bid. The search engine module 410 comprises logic for performing a user search request, in response to a winning bid, and formatting search results and serving the search results to the user. The advertising module 412 comprises logic for acquiring advertising to be displayed with the search results, providing the advertising to the user with search results, and paying the user a portion of advertising revenue received by the search engine service for the advertising.

The creation of competition between search engine services according to embodiments can be advantageous to end users because the monopoly power held by some search engines can be lessened. Moreover, a greater distribution of advertising revenue can be achieved according to embodiments.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed:

1. A method of selecting a search engine for performing a search request, comprising soliciting bids from a plurality of search engine services for performing a user search request in response to a user entering the search request into a device.

2. The method of claim 1, further comprising awarding the search request to a search engine service that submits a bid that best satisfies user criteria.

3. The method of claim 2, wherein user criteria comprises one or more of the following: user search engine preference, search results format preference, and price a search engine service is willing to pay to perform the search request.

4. The method of claim 3, wherein search results format preference includes whether the search results can be formatted for viewing by a mobile device, by a desktop device, and/or by an Internet Protocol television set top box.

5. The method of claim 2, wherein user criteria comprises a price a search engine service is willing to pay for one or more search terms in the search request.

6. The method of claim 5 wherein a price a search engine service is willing to pay for one or more search terms in the search request is dependent on one or more of the following: time of day, user location, user device, user profile, user service plan with a network service provider, previous user activity, user friends, association of the search request with a program, and association of the search request with advertising in other media.

7. The method of claim 6, wherein advertising in other media includes newspaper advertising, magazine advertising, and billboard advertising.

8. The method of claim 2, wherein the user device is connected to a communications network, and wherein soliciting bids and awarding the search request are performed by a communications network service.

9. A method of providing search results, the method comprising the following performed by a search engine service:
submitting a bid for the right to provide search results for a user search request, in response to receiving a bid request; and
providing search results to the user in response to a winning bid.

10. The method of claim 9, further comprising:
acquiring advertising to be displayed with the search results;
providing the advertising to the user with search results; and
paying the user a portion of advertising revenue received by the search engine service for the advertising.

11. The method of claim 10, further comprising paying a network service provider a portion of the advertising revenue.

12. The method of claim 9, further comprising:
acquiring advertising to be displayed with the search results;
providing the advertising to the user with search results; and
paying, a network service provider a portion of advertising revenue received by the search engine service for the advertising.

13. The method of claim 10, the bid includes information as to how the search results will comply with user criteria.

14. The method of claim 10, further comprising obtaining user criteria information prior to submitting the bid.

15. A computer apparatus, comprising a processor configured to solicit bids from a plurality of search engine services for performing a user search request in response to a user entering the search request into a user device.

16. The computer apparatus of claim 15, wherein the processor is configured to award the search request to a search engine service that submits a bid that best satisfies user criteria.

17. The computer apparatus of claim 15, wherein the user device is connected to a communications network, and wherein the computer apparatus is a server connected to the communications network.

18. The computer apparatus of claim 15, wherein user criteria comprises one or more of the following: user search engine preference, search results format preference, and price a search engine service is willing to pay to perform the search request.

19. The computer apparatus of claim 15, wherein search results format preference includes whether the search results can be formatted for viewing by a mobile device, by a desktop device, and/or by an Internet Protocol television set top box.

20. The computer apparatus of claim 15, wherein user criteria comprises a price a search engine service is willing to pay for one or more search terms in the search request.
